(19) United States
(12) Patent Application Publication
(10) Pub. No.: US 2018/0128025 A1
(43) Pub. Date: May 10, 2018

(54) Doorstop Apparatus

(71) Applicant: Miguel Godinez Estrada, Anaheim, CA (US)

(72) Inventor: Miguel Godinez Estrada, Anaheim, CA (US)

(21) Appl. No.: 15/711,489

(22) Filed: Sep. 21, 2017

Related U.S. Application Data
(60) Provisional application No. 62/397,891, filed on Sep. 21, 2016.

(51) Int. Cl. E05C 17/00; E05C 17/56; E05C 17/54

(52) U.S. Cl. CPC E05C 17/025; E05C 17/54; E05C 17/56

(57) ABSTRACT

A doorstop apparatus for holding a door in an open position is provided. The door has a door edge surrounded by a door frame. The doorstop apparatus comprises a block of material and at least one magnet mounted to the block of material. The block of material is capable of being positioned between the door edge and the door frame, the magnet interacting with either the door or the door frame.

### CLAIM OF PRIORITY

This patent application claims priority under 35 USC 119 (e) (1) from U.S. Provisional Patent Application Ser. No. 62/397,891 filed Sep. 21, 2016, of common inventorship herewith entitled, “Godinez Doorstopper,” which is incorporated herein by reference as though the same were set forth in its entirety.

### FIELD OF THE INVENTION

The present invention pertains to the field of doors, and more specifically to the field of door stoppers placed between a door and its frame to securely prop and keep the door open and allow unimpeded access to and from a room or building.

### BACKGROUND OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

The prior art has put forth several designs for door stoppers. Among these are:

U.S. Pat. No. 5,217,269 to Charles M. Wiltberger describes a portably handled doorstop with an elongated rod, a handle a one end, and a wedge shaped block at the other end of the rod. The rod extends for a length which is about equal to the distance between the user's hand in the lowermost position of the arm and the floor with the user in an upright position. A molded plastic one piece construction is formed with a cross section similar to an I-beam. A nonskid surface is provided on the base of the doorstop. A hook shaped projection at the top end of the doorstop enables it to be easily stored as needed.

U.S. Pat. No. 5,010,622 to Tamao Morita describes a doorstopper which facilitates opening and closing of a door by the attraction of a permanent magnet. The door stopper prevents damage to the attracting member by causing the attracting member and the attracted member comprising such a door stopper to gradually attract each other by a buffer action. The buffer action makes each one of the attracting member or the attracted member swingable so as to enable secure and stable attraction.

U.S. Pat. No. 4,494,784 to Harvey H. Haynes describes a doorstop for handicapped people, and particularly people in wheelchairs, which permits the person to push a self dosing door open and then lock it in an open position before passing through the doorway. The doorstop is comprised of a pivoted crossbar mounted at a convenient height traverse to the door connected by means of a lever to a doorstop at the corner of the door. The door is pushed open and the crossbar moved downward to lock the doorstop. After the person passes through the door, he simply lifts the crossbar to release the doorstop and allow the door to close.

None of these prior art references describe the present invention.

### SUMMARY OF THE INVENTION

It is an object of the present invention to provide a compact, portable, wedge doorstop device that is particularly configured to be placed between a door and its frame to securely prop and keep the door open and allow unimpeded access to and from a room or building.

The present invention is a doorstop apparatus for holding a door in an open position. The door has a door edge surrounded by a door frame. The doorstop apparatus comprises a block of material and at least one magnet mounted to the block of material. The block of material is capable of being positioned between the door edge and the door frame, the magnet interacting with either the door or the door frame.

In addition, the present invention includes a method for holding a door in an open position. The door has a door edge surrounded by a door frame. The method comprises providing a block of material, mounting at least one magnet to the block of material, positioning the block of material between the door edge and the door frame, and interacting the magnet with either the door or the door frame.

The present invention further includes a doorstop apparatus for holding a door in an open position. The door has a door edge surrounded by a door frame. The doorstop apparatus comprises a block of material with at least one section of the block of material being removed and at least one magnet mounted to the block of material. The block of material is capable of being positioned between the door edge and the door frame, the magnet interacting with either the door or the door frame.

### BRIEF DESCRIPTION OF THE DRAWINGS

FIG. 1 is a perspective view illustrating a doorstop apparatus, constructed in accordance with the present invention, showing a first embodiment shaped as an L.

FIG. 2 is a perspective view illustrating the doorstop apparatus, constructed in accordance with the present invention, showing a second embodiment shaped as a T.

FIG. 3 is a perspective view illustrating the first embodiment of the doorstop apparatus, constructed in accordance with the present invention, releasably mounted between a door and a door frame.

FIG. 4 is another perspective view illustrating the first embodiment of the doorstop apparatus, constructed in accordance with the present invention, releasably mounted between a door and a door frame.

FIG. 5 is a perspective view illustrating the second embodiment of the doorstop apparatus, constructed in accordance with the present invention, releasably mounted between a door and a door frame.

FIG. 6 is another perspective view illustrating the second embodiment of the doorstop apparatus, constructed in accordance with the present invention, releasably mounted between a door and a door frame.

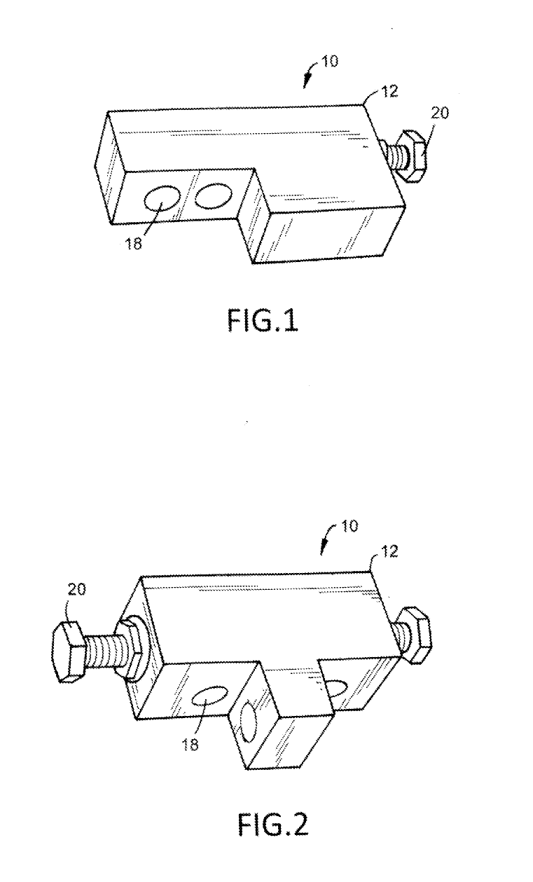

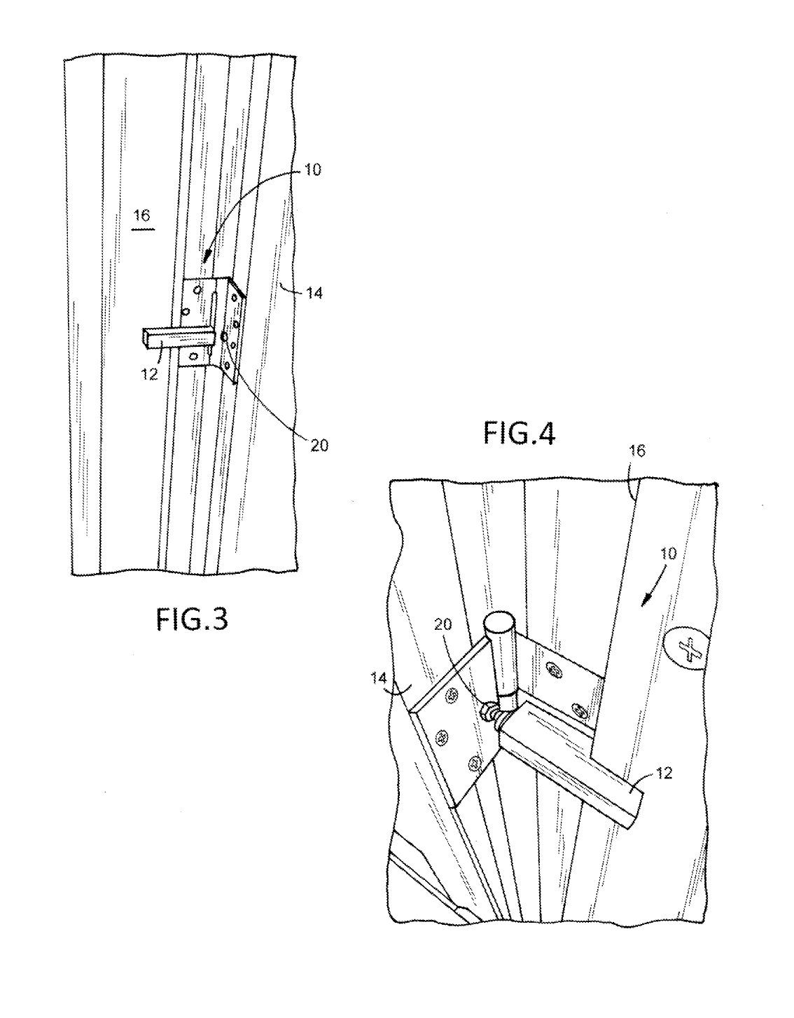

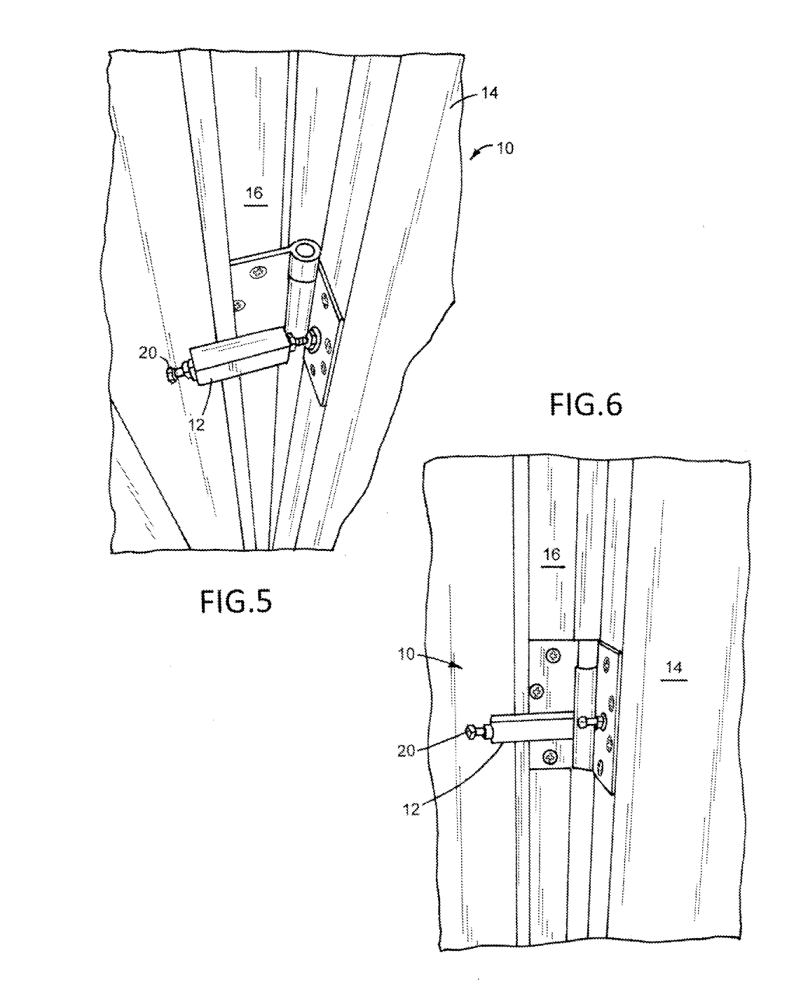

### DETAILED DESCRIPTION OF THE INVENTION

The present invention, hereinafter referred to as a Doorstop Apparatus, indicated generally at 10, is a compact, portable, wedge block device 12 configured to be placed between a door 14 and a door frame 16 to securely prop and keep the door 14 open and allow unimpeded access to and from a room or building. Magnetic and adjustable, the Doorstop Apparatus 10 fits between hinged surfaces of a door 14 and its door frame 16. The Doorstopper Apparatus 10 provides users with a practical and easily installable means of securing and keeping a door 14 open without ever having to bend over.

Preferably, fabricated of durable plastic, wood or metal materials, the Doorstop Apparatus 10 of the present invention is produced in two embodiments. The Doorstop Apparatus 10 includes a block 12 of material preferably formed in a rectangular cuboid shape. In a first embodiment, the block 12 has a portion removed thereby forming an L shape. Preferably, the L shaped block 12 measures approximately three and one half (3½″) inches in length on its long side, two (2″) inches in length on its short base, and one (1″) inch in depth or height.

In a second embodiment of the Doorstop Apparatus 10 of the present invention, the block 12 has two portions removed thereby forming a T shape. Preferably, the top of the T shaped block 12 measures approximately three (3″) inches in width and one (1″) inch in depth or height. The stem of the T shaped block 12 preferably measures approximately one (1″) inch in width and one (1″) inch in depth or height.

The L and T shaped embodiments of the Doorstop Apparatus 10 of the present invention are constructed with the same components and operate in the same manner. A series of magnets 18 are positioned on outer surfaces of the block 12 facilitate security of the Doorstop Apparatus 10 to a metal hinge or door 14. The Doorstop Apparatus 10 is adjustable by means of a spring loaded screw 20 affixed to one or more ends of the block 12.

Simple in construction, the Doorstop Apparatus 10 of the present invention is extremely effective in application and use. A user positions the Doorstop Apparatus 10 within the space where the door 14 meets the door frame 16. After a door 14 is opened to its needed width, the user inserts a Doorstop Apparatus 10 so that one end is attached to the hinge surface and the corner section of the L or T block 12 is flush against the door jamb 16. In this manner, the door 14 is instantly secured in an open position and will remain so until the user removes the Doorstop Apparatus 10.

The Doorstop Apparatus 10 provides anyone working in an area obstructed by a door 14 with a simple and effective means of securing it in an open position. An unobtrusive mounting brace that is able to steadfastly secure doors 14 of any weight, the Doorstop Apparatus 10 eliminates time consuming and annoying problems of hinged doors 14 moving back and forth when it is necessary to constantly enter and exit, as well as when installation and repair tasks need to be performed on the door 14 itself. Using the present invention, duties are easily and expediently completed. The Doorstop Apparatus 10 enables workers to attend to tasks by themselves without having to ask another individual to hold the door 14. Portable and lightweight, the Doorstop Apparatus 10 is carried easily in one's pocket or toolbox. Durably constructed of high quality materials, the Doorstop Apparatus 10 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A doorstop apparatus for holding a door in an open position, the door having a door edge surrounded by a door frame, the doorstop apparatus comprising:
a block of material; and
at least one magnet mounted to the block of material;
wherein the block of material is capable of being positioned between the door edge and the door frame, the magnet interacting with either the door or the door frame.

2. The doorstop apparatus of claim 1 wherein the block of material is constructed from a material selected from the group consisting of plastic, wood, and metal.

3. The doorstop apparatus of claim 1 wherein the block of material is formed in a rectangular cuboid shape.

4. The doorstop apparatus of claim 3 wherein the block of material has an L shape.

5. The doorstop apparatus of claim 4 wherein the L shaped block measures approximately three and one half (3½″) inches in length on a long side, two (2″) inches in length on a short base, and one (1″) inch in depth or height.

6. The doorstop apparatus of claim 3 wherein the block of material has a T shape.

7. The doorstop apparatus of claim 6 wherein a top of the T shaped block measures approximately three (3″) inches in width and one (1″) inch in depth or height and a stem of the T shaped block measures approximately one (1″) inch in width and one (1″) inch in depth or height.

8. The doorstop apparatus of claim 1 and further comprising:
a series of magnets positioned on the outer surfaces of the block of material.

9. The doorstop apparatus of claim 1 and further comprising:
at least one spring loaded screw affixed to one or more ends of the block of material.

10. The doorstop apparatus of claim 1 wherein the block of material is compact and portable, the block of material configured to be placed between a door and its frame to securely prop and keep the door open and allow unimpeded access to and from a room or building.

11. A method for holding a door in an open position, the door having a door edge surrounded by a door frame, the method comprising:
providing a block of material;
mounting at least one magnet to the block of material;
positioning the block of material between the door edge and the door frame; and
interacting the magnet with either the door or the door frame.

12. A doorstop apparatus for holding a door in an open position, the door having a door edge surrounded by a door frame, the doorstop apparatus comprising:
a block of material, at least one section of the block of material being removed; and
at least one magnet mounted to the block of material;
wherein the block of material is capable of being positioned between the door edge and the door frame, the magnet interacting with either the door or the door frame.

13. The doorstop apparatus of claim 12 wherein the block of material is constructed from a material selected from the group consisting of plastic, wood, and metal.

14. The doorstop apparatus of claim 12 wherein the block of material is formed in a rectangular cuboid shape.

15. The doorstop apparatus of claim 14 wherein the block of material has an L shape.

16. The doorstop apparatus of claim 14 wherein the block of material has a T shape.

17. The doorstop apparatus of claim 12 and further comprising:
a series of magnets positioned on the outer surfaces of the block of material.

18. The doorstop apparatus of claim 12 and further comprising:
at least one spring loaded screw affixed to one or more ends of the block of material.

19. The doorstop apparatus of claim 12 wherein the block of material is compact and portable, the block of material configured to be placed between a door and its frame to securely prop and keep the door open and allow unimpeded access to and from a room or building.
